(19) United States
(12) Patent Application Publication
(10) Pub. No.: US 2008/0060395 A1
(43) Pub. Date: Mar. 13, 2008

(54) Motor Vehicle Door Lock

(75) Inventor: Dirk Hanisch, Koeln (DE)

Correspondence Address: Omori & Yaguchi USA, LLC;8 Penn Center, 1628 John F. Kennedy Blvd, Suite 1300, Philadelphia, PA, 19103, US

(73) Assignee: KIEKERT AKTIENGESELLSCHAFT, 42579 Heiligenhaus (DE)

(21) Appl. No.: 10/586,028

(22) PCT Filed: Jan. 12, 2005
(86) PCT No.: PCT/DE05/00025

§ 371 Date: May 22, 2007

(30) Foreign Application Priority Data
Jan. 13, 2004 (DE) 10 2004 001 982.7

(51) Int. Cl. E05B 9/00; E05B 65/12

(52) U.S. Cl. 70/237

(57) ABSTRACT

A motor vehicle door lock (3) provided for connection to a vehicle door, in which the motor vehicle door lock (3) comprises a carrier plate (4) whereon the locking pieces (2, 21, 22) are mounted, and a lock housing (32) which at least partially surrounds the locking pieces (2, 21, 22) comprising the carrier plate (4), comprising a counter piece (34) formed from the side (36) of the lock housing (32), which is opposite to the carrier plate (4), the counter piece (34) being provided in such a way that it co-operates with a connection element (7) in the vehicle door (8) by means of a through opening (43) in the carrier plate (4).

### CROSS REFERENCE TO RELATED APPLICATIONS

This application claims priority under 35 U.S.C. 119 and 35 U.S.C. 365 based upon German Patent Application No. 10 2004 001 982.7, filed on Jan. 13, 2004. The entire disclosure of the aforesaid application is incorporated herein by reference.

### FIELD OF THE INVENTION

The invention relates to a motor vehicle door lock which is connected to a vehicle door in which the motor vehicle door lock comprises a carrier plate whereon the locking pieces are mounted and a lock housing which at least partially surrounds the locking pieces comprising the carrier plate.

### BACKGROUND OF THE INVENTION

Usually, used motor vehicle door locks are supplied as separately installed parts, which are then installed by the vehicle manufacturer. In most cases, the motor vehicle door lock contains moving parts that have to ensure the correct locking of the vehicle door. In most cases, catches on the door lock side are used, co-operating with pins or hinges on the chassis side to lock the motor vehicle door.

The locking pieces have to absorb considerable forces, as break-ins as well as an unwanted opening of the door, in case of an accident, must be prevented. The catches and the pawl locking the catch and the parts in the motor vehicle door lock on which these are mounted must therefore be mounted securely.

As a result of the solid connection of the moved parts on the carrier plate, the generation of noise and transmission onto and by the carrier plate can hardly be avoided, in particular due to the chassis twisting during driving.

Generally, the motor vehicle door lock is secured by bolts that extend through the door panel and are bolted to the metal carrier plate. For this purpose, threads cut into the carrier plate are provided in most cases.

As a result of this type of fixing, the generation of noise and transmission onto the door panel can only be partially reduced with considerable silencing efforts.

In modern vehicles, however, more and more emphasis is placed on ensuring that moving parts, such as motor vehicle door locks operate as silently as possible. Conventional motor vehicle door locks therefore have to be equipped with means requiring additional assembly or with costly low-noise fixings, which is expensive and laborious.

Another disadvantage in the production of standard vehicle door locks is the high number of used individual parts that have to be individually assembled as this is costly. At the same time, the individual parts and assembled unit have to fulfill high mechanical requirements with regard to stability under stress, in particular in case of a crash.

### SUMMARY OF THE INVENTION

The invention has the task of reducing the aforementioned disadvantages and of providing an improved motor vehicle door lock and to improve, in particular, the overall process sequence of production with regard to its economic efficiency and quality.

This task is solved by a motor vehicle door lock provided in connection with a vehicle door, as described in claim 1.

The invention provides a connection counter piece formed from the side of the housing which is opposite the carrier plate in such a manner that it co-operates with a connection element in the vehicle door by means of a through opening in the carrier plate.

The invention suggests avoiding the until now standard connection of a motor vehicle door lock consisting of a direct connection between the motor vehicle door lock and the carrier plate itself as this has until now acted as a noise transmission bridge. Where the lock housing is produced from a noise-reducing material, the connecting element connecting the motor vehicle door lock to the vehicle door is not in contact with the carrier plate. This allows optimum noise reduction.

Preferably, the connection counter piece consists of a cone-shaped vertically extending dome.

Consequently, a particularly advantageous and thus preferred embodiment of the invention provides that on the side of the carrier plate facing the lock housing and around the through opening, a dome/cone seat is formed for co-operation with the conical dome, said seat having a funnel-shaped opening for accommodating the cone-shaped dome. This creates a self-centering connection guaranteeing an optimum process sequence during assembly. As a result of the thus created large conical support surface, lateral forces between the lock housing and the carrier plate are not transmitted onto the connection element.

The dome/cone seat is preferably produced by extrusion coating, using the so-called Outsert process. During this process, the plastic material is sprayed directly around the parts to be enclosed and edges, openings or projections on the metal carrier serve as an anchor or projection for the plastic. Assembly of the extruded parts is therefore not required. As a result, numerous process steps and material for the parts otherwise required for assembly are saved and costly logistics and storekeeping of parts that would otherwise have to be manufactured and supplied individually is also no longer required.

The Outsert method allows the production of very precise shapes with very low tolerances. As also no installation is required, any potential tolerances of the geometries associated therewith, are also avoided.

In an advantageous embodiment of the invention a bearing for the thread of a bolt extending through the through opening is provided in the connection piece. This bearing can be a thread but also an opening in a material allowing the use of self-cutting bolts as connection element.

Advantageously, the carrier plate is made from a shape-retaining material, in particular metal.

Preferably, the locking pieces are a catch and/or a pawl of the motor vehicle door lock.

In a particular advantageous further development of the invention, the external edges and/or edges of openings or punched-out sections of the carrier plate contain a plastic extrusion coating covering the edges at least partially, said plastic extrusion coating having, in particular, being applied using the Outsert method. As a result, potential injuries can be prevented and the usually required labor-intensive deburring is no longer necessary in most cases. The extrusion coating also protects the edges against corrosion as open punched or cut out areas are sealed and no longer in contact with air. As a result of the extrusion coating also thicker material can be used, whose edges do not contain an earlier applied protective layer, e.g. zinc layer because of the processing—e.g. punching.

The extrusion coating also allows a better design in the visible area of the door lock, as any type of surface and forms can be achieved.

In order to reduce noise or friction, a further advantageous embodiment of the invention provides that at least partially between the locking pieces and the carrier plate and/or the frame box and/or the lock housing, a layer of extrusion coating is applied, in particular by the Outsert method. Such an extrusion coating applied from the outside can, apart from reducing the noise, also achieve an improved design of the entire motor vehicle door lock.

An embodiment characterized by an efficient production provides that the plastic extrusion coatings on the bearing plate are produced in a single production step, using the Outsert method.

Advantageously, a transportation fixing extends vertically from the carrier plate for connecting the lock housing to the carrier plate containing snap-in projections for the transportation fixing which are provided on an edge or a formed shape on the lock housing for locking.

Preferably, the lock housing and/or the conical dome and/or the transport fixing are made from plastic, in particular a technical plastic and/or fiberglass or carbon-fiber reinforced plastic.

Advantageously, the bearing plate is formed by a frame box of a motor vehicle door lock. If the Outsert method is used, also the lock housing enclosing the locking pieces on the bearing plate can be produced in one piece.

Preferably, a noise-reducing layer is provided between the vehicle door and the motor vehicle door lock with the noise-reducing layer having been applied by plastic extrusion coating, in particular by using the Outsert method.

Other advantages, peculiarities and useful further developments of the invention are shown in the further subclaims or their subcombinations.

### BRIEF DESCRIPTION OF THE DRAWINGS

Below, the invention is explained in more detail with reference to drawings. The individual diagrammatic views are as follows:

FIG. 1 shows a top view from the front onto a carrier plate containing, according to the invention, a dome/cone seat for guiding the connection counter pieces,

FIG. 2 shows a top view onto a lock housing with connection counter pieces vertically extending therefrom,

FIG. 3 shows a top view from the rear onto a motor vehicle door lock according to the invention comprising the carrier plate from FIG. 1 and the lock housing from FIG. 2,

FIG. 4 shows a top view from the front onto the motor vehicle door lock of FIG. 3,

FIG. 5 shows a diagrammatic section through a lock housing and a carrier plate prior to their assembly,

FIG. 6 shows a diagrammatic section through lock housing and a carrier plate after assembly in a motor vehicle door lock,

FIG. 7 shows a diagrammatic section through a motor vehicle door lock prior to being placed on a vehicle door,

FIG. 8 shows a diagrammatic section through a motor vehicle door lock after having been placed on a vehicle door,

FIG. 9 shows a diagrammatic section through a motor vehicle door lock onto a vehicle door with a connection element, and

FIG. 10 shows a diagrammatic section through a motor vehicle door lock installed on a vehicle door.

### DETAILED DESCRIPTION OF THE INVENTION

The same reference figures in the drawings refer to the same elements or elements that function in the same way.

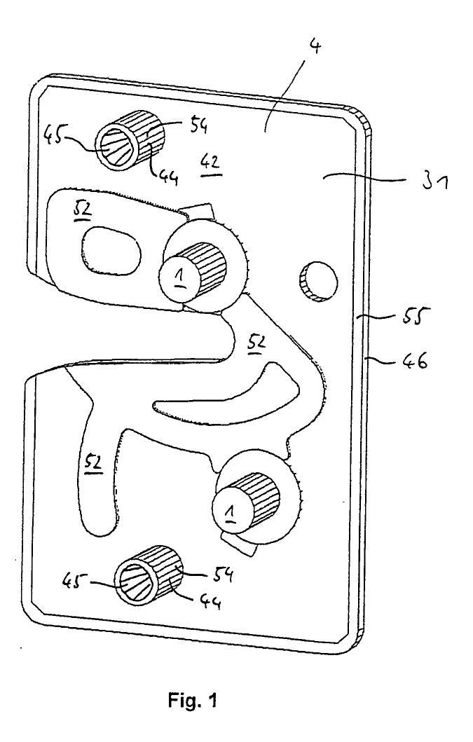

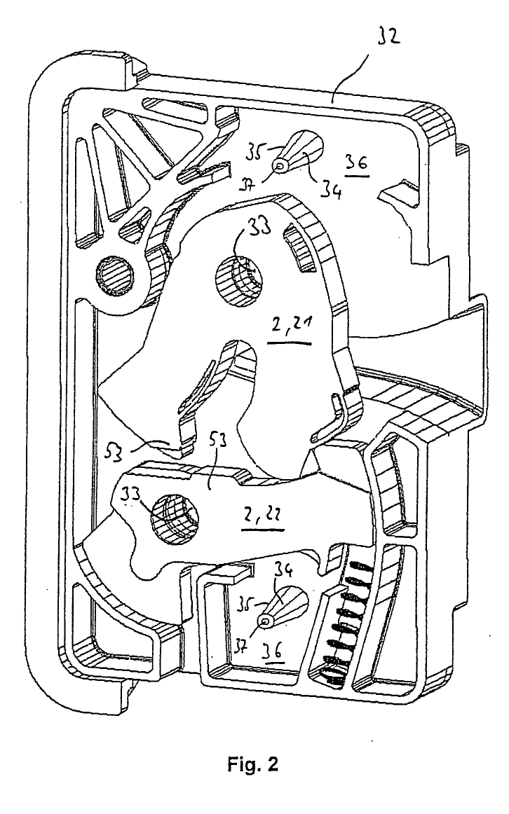

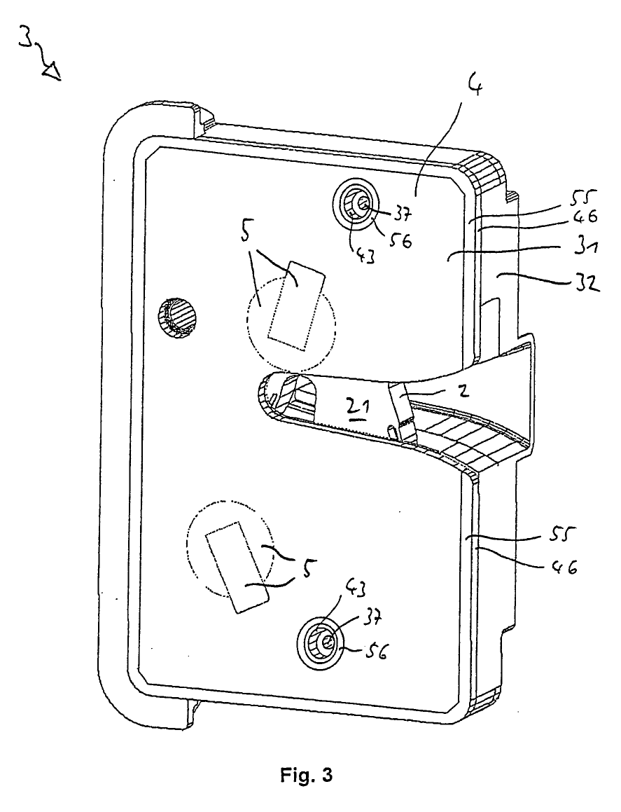

FIG. 1 is a schematic representation of a top view from the front onto a metal bearing plate 4, in the example a frame box 31 of a motor vehicle door lock 3. Bearing rods 1 for mounting locking pieces and two dome/cone seats 44 of the invention extend vertically from the surface 42 of the carrier plate. The dome/cone seats 44 contain a funnel-shaped opening 45 for accommodating the cone-shaped dome (see FIG. 2). The dome/cone seats 44 have been formed by plastic extrusion coating 54 around through openings 43 (see FIG. 3) for a connection element and have been produced using the Outsert method.

Also a layer of plastic extrusion coating 52 was applied onto the surface of the carrier plate 4, serving partly as gliding aid and sound insulation between the locking pieces and the bearing plate.

The edge 46 of the carrier plate 4 is also covered by plastic extrusion coating 55, sealing it from exposure to air and preventing risk of injury from sharp burrs.

The catch 21 and the pawl 22 are placed onto the ends of the bearing rods and pushed down against the bearing plate 4.

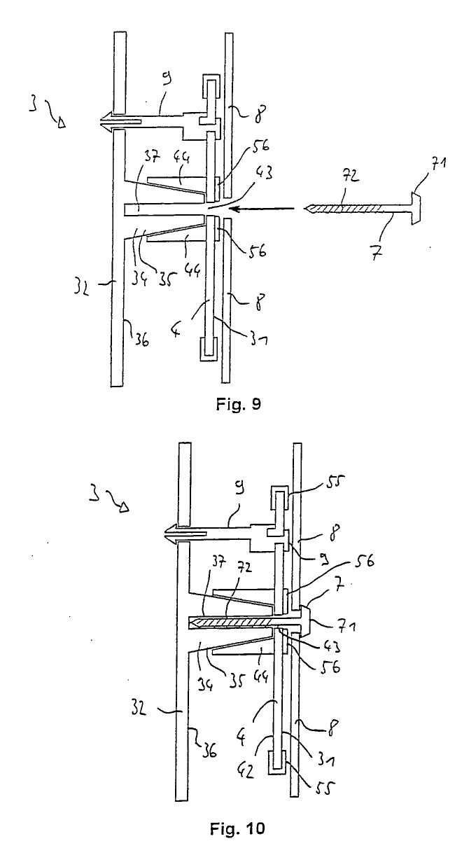

FIG. 2 shows the lock housing 32 with connection counter pieces 34 formed from the side 36 of the lock housing 32, which is opposite the carrier plate 4 and said pieces having been formed by vertically extending cone-shaped domes 35. The cone-shaped domes 35 each contain a central bearing 37 for the connection element (see FIG. 9 and FIG. 10 below).

The representation also shows the locking pieces 2, in form of a catch 21 and a pawl 22 in the position they occupy on the bearing pins 1. The bearing pins are mounted with their ends in the seats 33 of the lock housing 32.

In order to achieve further noise reduction, the catch 21 and the pawl 22 are also partly coated with a plastic extrusion coating 53.

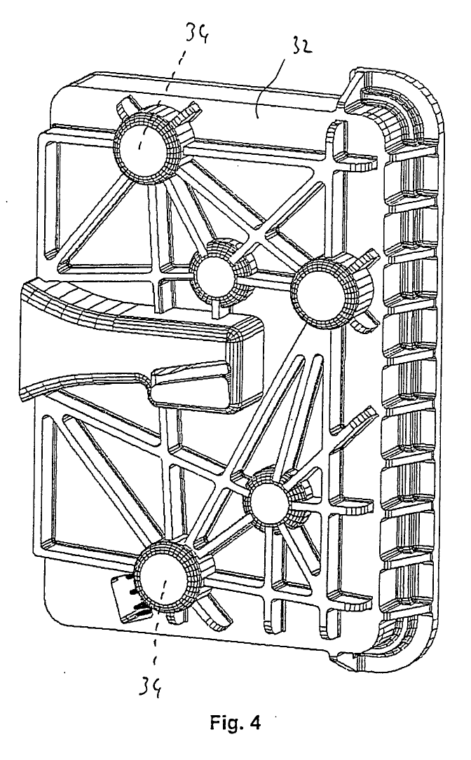

FIG. 3 and 4 show a top view from the rear and from the front onto a fully installed motor vehicle door lock 3 of the invention. The frame box 31 (carrier plate 4) and the locking pieces 2 mounted thereon are enclosed by the lock housing 32.

A noise-reducing layer 56 is formed around the through opening 43, serving as a noise muffler between the vehicle door and the motor vehicle door lock 3 (see also FIG. 8). The noise-reducing layer 56 is formed by a plastic extrusion coating; in the example, this is the same plastic extrusion coating 54 as used for forming the dome/coat seat 44.

The tip of the cone-shaped dome 35 with the opening of bearing 37 for the connection element can be seen through the through opening 43.

In this view also a plastic extrusion coating 5 of the bearing pins 1 can be seen from below.

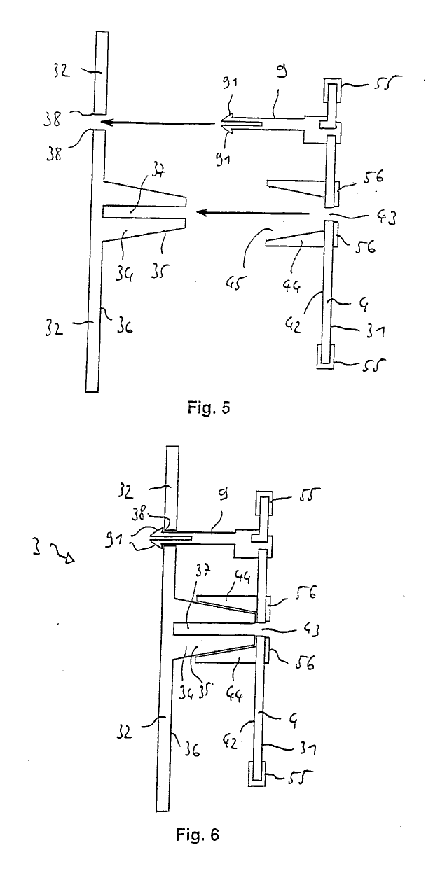

FIGS. 5 to 10 show in individual diagrammatic sections, individual example situations of the assembly of a motor vehicle door lock and its installation in the vehicle door.

FIG. 5 shows the lock housing 32 and the frame box 31 (carrier plate 4) in a still unconnected state.

A transportation fixing 9 extends vertically from the carrier plate 4 containing two snap-in projections 91 at its tip which engage with an edge 38 on the lock housing 32 after being pushed through the opening (see FIG. 6). In order to engage, the lock housing 32 and the frame box 31 must be moved towards each other.

Also a section of the plastic extrusion coating 55 of the edges is shown.

In order for the connection counter piece 34, e.g. the vertically extending cone-shaped dome 35 formed from the side 36 of the lock housing 32, which is opposite to the carrier plate 4, to be positioned exactly opposite to the through opening 43 on the surface 42 of the carrier plate 4, the dome/cone seat 44 on the carrier plate 4 was formed using the Outsert method. The funnel-shaped opening 45 ensures that the cone-shaped dome 35 is reliably arranged in its end position.

After the transportation fixing 9 has engaged with the edges 38, the through opening 43 is in FIG. 6 exactly in line with the bearing 37 for the connection element, which will subsequently extend through the through opening 43. The thus fully assembled motor vehicle door lock 3 is safely held together by the transportation fixing 9. The diagrammatic section only shows one type of transportation fixing. Any other engaging elements or other catches preventing opening, are possible.

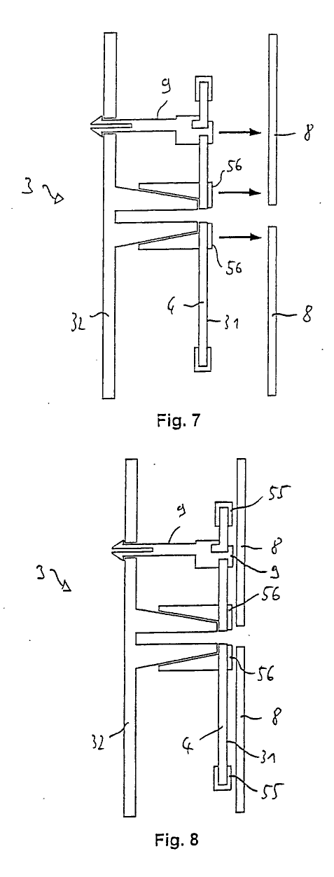

During installation in a vehicle, the ready motor vehicle door lock 3 is positioned onto a panel of a vehicle door 8 as shown in FIG. 7. For installation, the opening in the panel of the vehicle door 8, the through opening 43 and the bearing 37 for the connection element are positioned in line with each other.

FIG. 8 shows the positioned motor vehicle door lock 3 on the panel of the vehicle door 8. The vehicle door 8 is not in direct contact with the carrier plate 4. For noise reduction and preventing the transfer of vibration, the noise-reducing layer 56 is positioned between the vehicle door 8 and the motor vehicle door lock 3. The noise-reducing layer is formed by the plastic extrusion coating 54 of the dome/cone seat 44, which is also applied using the Outsert method. In the same way, the transportation fixing 9 with a projecting area forms a noise-reducing layer and the enclosing plastic extrusion coating 55 of the edges.

FIG. 9 shows the state shortly before the bolt 71, as connection element 7, is inserted through the panel of the vehicle door and through opening 43 in the carrier plate 4 into the bearing 37 of the connection counter piece 34 formed out of the lock housing 32.

FIG. 10 finally shows the motor vehicle door lock 3 fixed to the vehicle door 8. When screwing into the bearing 37, the bolt 71 has cut a thread into the previously smooth plastic wall of the bearing 37, corresponding to the thread 72 of the bolt.

1. A motor vehicle door lock (3) provided for connection to a vehicle door,
in which the motor vehicle door lock (3) comprises a carrier plate (4) whereon the locking pieces (2, 21, 22) are mounted, and a lock housing (32) which at least partially surrounds the locking pieces (2, 21, 22) comprising the carrier plate (4), comprising:
a counter piece (34) formed from the side (36) of the lock housing (32), which is opposite to the carrier plate (4), said counter piece (34) being provided in such a way that it co-operates with a connection element (7) in the vehicle door (8) by means of a through opening (43) in the carrier plate (4).

2. The motor vehicle door lock according to claim 1,
wherein the connection counter piece (34) is formed by a vertically extending cone-shaped dome (35).

3. The motor vehicle door lock according to claim 2,
wherein on the carrier plate (4) and on the side (42) facing the lock housing (32), a dome/cone seat (44) is formed around the through opening (43) for co-operation with the conical dome (35), said seat containing a funnel-shaped opening (45) for accommodating the cone-shaped dome (35).

4. The motor vehicle door lock according to claim 3,
wherein the dome/cone seat (44) is produced by plastic extrusion coating (54) and said plastic extrusion coating (54) being applied, in particular, using the Outsert method.

5. The motor vehicle door lock according to claim 1,
wherein inside the connection counter piece (34) a bearing (37) for the thread (72) of a bolt (71) extending through the through opening (43) is provided.

6. The motor vehicle door lock according to claim 1,
wherein the carrier plate (4) is formed from a shape-retaining material, in particular metal.

7. The motor vehicle door lock according to claim 1,
wherein the carrier plate (4) is formed by a frame box (31) of a motor vehicle door lock (3).

8. The motor vehicle door lock according to claim 1,
wherein the locking pieces (2) are a catch (21) and/or a pawl (22) of the motor vehicle door lock (3).

9. The motor vehicle door lock according to claim 1,
wherein the external edges (46) and/or edges of openings or cut-outs of the carrier plate (4) are at least partially enclosed by a plastic extrusion coating (55) covering the edges (46), with the plastic extrusion coating having, in particular, been applied using the Outsert method.

10. The motor vehicle door lock according to claim 1,
a plastic extrusion coating (52) layer, in particular using the Outsert method, is applied at least partially between the locking pieces (2, 21, 22) and the carrier plate (4) and/or the frame box (31) of the motor vehicle door lock (3) and/or the lock housing, where the frame box (31) forms the carrier plate (4).

11. The motor vehicle door lock according to claim 1,
wherein a plastic extrusion coating (5, 51, 52, 53, 54, 55) on the carrier plate (4) is produced in a single production step, using the Outsert method

12. The motor vehicle door lock according to claim 1,
wherein a transportation fixing (9) vertically extending from the carrier plate (4) is provided for connecting the lock housing (32) to the carrier plate (4) and in which the transportation fixing (9) contains at least one snap-in projection (91) for engaging with an edge (38) or a form in the lock housing (32).

13. The motor vehicle door lock according to claim 1
wherein the lock housing (32) and/or a vertically extending cone-shaped dome conical dome (35) forming the counter piece (34) and/or the transportation fixing (9) are produced from plastic, in particular a technical plastic and/or fiberglass or carbon fiber-reinforced plastic.

14. The motor vehicle door lock according to claim 3,
wherein a noise-reducing layer (56) is provided between the vehicle door (8) and the motor vehicle door lock (3), with the noise-reducing layer being applied by plastic extrusion coating using, in particular, the Outsert method and in which the noise-reducing layer consists, in particular, of a plastic extrusion coating (56, 55) of the dome/cone seat (44) and/or a transportation fixing (9); for connecting the lock housing (32) to the carrier plate (4), and/or a plastic extrusion coating (55) covering and at least partially enclosing the external edges (46) and/or edges of openings or cut-outs of the carrier plate (4).
